(19) United States
(12) Patent Application Publication
(10) Pub. No.: US 2003/0163390 A1
(43) Pub. Date: Aug. 28, 2003

(54) Method of searching and ordering books via the internet

(75) Inventor: Sung Woo Yang, Los Angeles, CA (US)

Correspondence Address: CHARLES C.H. WU, 7700 IRVINE CENTER DRIVE, SUITE 710, IRVINE, CA, 92618-3043, US

(73) Assignee: TECHNO MECCA, INC.

(21) Appl. No.: 10/080,309

(22) Filed: Feb. 22, 2002

(51) Int. Cl. G06F 17/60

(52) U.S. Cl. 705/27

(57) ABSTRACT

A method of searching and ordering books via the Internet is disclosed. This method allows business to business customers that often require to search and purchase thousands of books a quick and simple way of searching and ordering books via the Internet, as well as keeping track of the previously purchased books to in order to avoid duplicative purchases. A customer copies and pastes book identifying information, such as International Standard Book Number, from the customer's electronic file to the window displayed in the vendor's web page. A main database containing all the books carried by the vendor is searched, generating a list of available books matching the book identifying information entered by the customer. A database containing the previously ordered books is also searched and displayed. The customer can order the books from the list of available books by selecting the desired books. At the same time, the customer is able to see the previously ordered books.

### FIELD OF THE INVENTION

The present invention relates to a method of searching and ordering books via the Internet, and more particularly, a time-saving and convenient method of searching for multiple books, reviewing the search results, reviewing the previously ordered books and placing book orders on line.

### BACKGROUND OF THE INVENTION

With the advent of the Internet, more and more consumers are purchasing merchandize on line. This is especially true in the area of book sales. A growing number of companies offer the convenience of searching their on line databases containing thousands of book titles. Such search can be done by a book identifying information, such as book title, author, subject, ISBN (an International Standard Book Number—a unique number assigned to every book published in the world that is normally printed on a book cover as a bar code), and many others. Upon finding the desired book, a customer would have an option of ordering and paying for the book on line.

Conventionally, a customer would search for desired books and upon finding them “add them to the cart”, i.e. place an order one book at a time. This works well with consumers who desire to purchase just a few books. Business to business customers, on the other hand, often require to search and purchase thousands of books, as well as keep track of the previously purchased books to in order to avoid duplicative purchases.

Accordingly, there is a need for a method of searching and ordering books via the Internet that allows to search and purchase thousands of books, as well as keep track of the previously purchased books to in order to avoid duplicative purchases by way of a simple one time search, rather than one book at a time.

### SUMMARY OF THE INVENTION

This invention takes advantage of the fact that many business to business customers have a list containing book identifying information (such as ISBNs) for the desired books in an electronic format, or can easily compile such a list (ISBNs and other book identifying information is available from the publishers). This can be a Microsoft Excel, Microsoft Word, text or other file.

A book vendor stores book identifying information for all the books it carries in a main database on its server system. The book vendor also stores book identifying information for all the books previously ordered by a particular customer in a customer database. The customer copies book identifying information for the desired books from the customer's file and pastes it in the vendor's web page accessible to the customer via the Internet. In response to the book identifying information entered by the customer, both the main database and the customer database are searched to match the book identifying information entered by the customer with the book identifying information stored in the main database and the customer database. The matching book identifying information from both the main database and the customer database is retrieved as a search result comprising the book identifying information for the books that the customer desires to purchase, as well as a previous orders result comprising book identifying information for the books that the customer has previously purchased, prompting the customer to select whether or not to order duplicative books.

### BRIEF DESCRIPTION OF THE DRAWING FIGURES

FIG. 1 through FIG. 4 depict web pages viewed by a customer employing a method of searching and ordering books via the Internet according to this invention.

### DETAILED DESCRIPTION OF THE PREFERRED EMBODIMENT

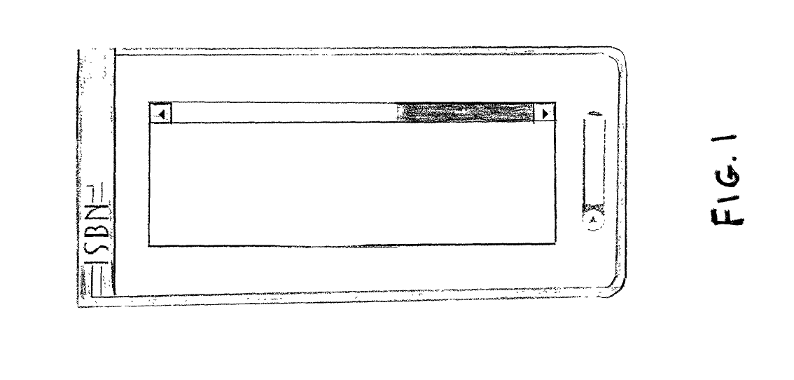

The present invention will be better understood with reference to FIG. 1 through FIG. 4 depicting web pages viewed by a customer employing a method of searching and ordering books via the Internet according to this invention.

Viewing FIG. 1, there is shown an input means for entering book identifying information under control of the customer system, and more specifically, a window where the customer can enter ISBNs (International Standard Book Numbers) for the desired books. The easiest way to enter ISBNs into said window is to copy ISBNs from the customer's electronic file (this can be a Microsoft Excel, Microsoft Word, text or other file) and paste them into said window.

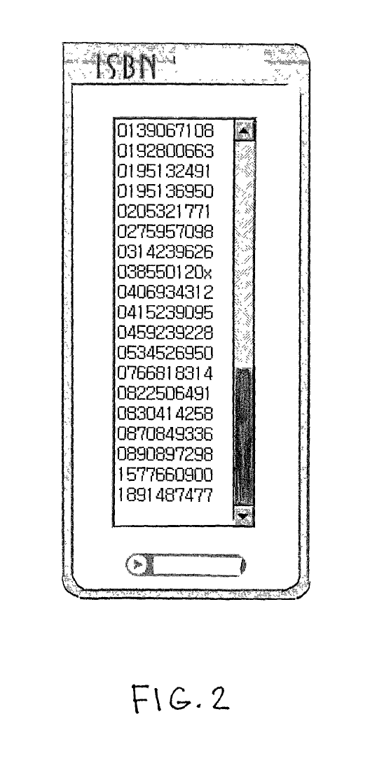

Viewing FIG. 2, there is shown said window with the ISBNs pasted into it. The customer, under control of the customer system, would click on the button below said window thus initiating, under control of the vendor server system, accessing a main database where book identifying information for every book carried by the vendor has been previously stored, as well as accessing, under control of the vendor server system, a customer database where book identifying information for every book previously ordered by a customer is stored.

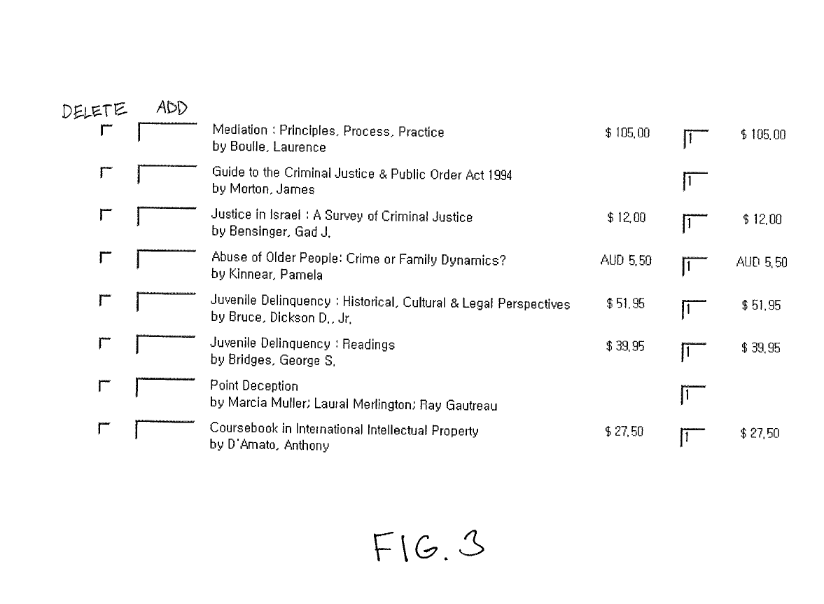

When the main database is accessed, under control of the vendor server system, the book identifying information entered by the customer in the window in FIG. 2 is matched with the book identifying information stored in the main database. This is followed by generating a search result comprising the matching book identifying information. Viewing FIG. 3, there is shown said search result, displayed under control of the customer system, indicating the available books (by title, author and price) matching the ISBNs entered by the customer in the window shown in FIG. 2.

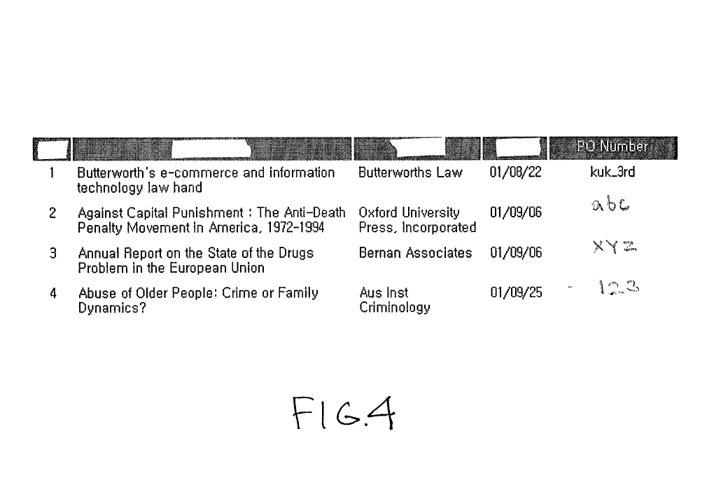

When the customer database is accessed, under control of the vendor server system, the book identifying information entered by the customer is matched with the book identifying information stored in the customer database. This is followed by generating a previous orders result, displayed under control of the customer system, comprising the matching book identifying information. Viewing FIG. 4, there is shown said previous orders result (by title, publisher, date of order and purchase order number) indicating the books previously ordered by the customer matching the ISBNs entered by the customer in the window shown in FIG. 2. The information displayed in FIG. 4 prompts the customer to select whether or not to order duplicative books or delete them from the order.

Viewing again FIG. 3, the customer has an option of either deleting or adding the specific book by clicking on the corresponding icon located on the left side of the book identification information shown in FIG. 3. In response to the “add” or “delete” icons clicked by the customer, the vendor generates book orders.

The scope of the present invention is defined by the claims that follow.

What is claimed is:

1. A method of searching and ordering books via the Internet comprising the steps of:
(a) under control of a vendor server system, book identifying information for every book carried by the vendor in a main database;
(b) under control of the vendor server system book identifying information for every book previously ordered by a customer in a customer database;
(c) under control of the customer system, displaying input means for entering book identifying information;
(d) under control of the vendor server system, in response to the book identifying information entered by the customer in said input means, accessing the main database to match the book identifying information entered by the customer with the book identifying information stored in the main database and generating a search result comprising the matching book identifying information;
(e) under control of the customer system, displaying said search result;
(f) under control of the vendor server system, in response to book identifying information entered by the customer in said input means, accessing the customer database to match the book identifying information entered by the customer with the book identifying information stored in the customer database and generating a previous orders result comprising the matching book identifying information;
(g) under control of the customer system, displaying said previous orders result;
(h) under control of the customer system, displaying means for entering book orders;
(i) under control of the vendor server system, in response to the book orders entered by the customer in said input means for entering book orders, generating book orders.

2. A method as in claim 1, wherein said book identifying information further comprises an international standard book number.

3. A method as in claim 1, wherein said book identifying information further comprises a title.

4. A method as in claim 1, wherein said book identifying information further comprises an author.

5. A method as in claim 1, wherein said book identifying information further comprises a subject.

6. A method as in claim 1, wherein the step of accessing the main database to match the book identifying information entered by the customer with the book identifying information stored in the main database and generating a search result comprising the matching book identifying information is performed simultaneously with the step of accessing the customer database to match the book identifying information entered by the customer with the book identifying information stored in the customer database and generating a previous orders result comprising the matching book identifying information.

7. A method as in claim 1, wherein the step of displaying said search result is performed simultaneously with the step of displaying said previous orders result.
